(19) United States
(12) Patent Application Publication
(10) Pub. No.: US 2011/0215129 A1
(43) Pub. Date: Sep. 8, 2011

(54) Material wrap dispenser

(76) Inventor: Michael B. McGuigan, Fort Myers Beach, FL (US)

(21) Appl. No.: 12/659,279

(22) Filed: Mar. 2, 2010

(51) Int. Cl. B26F 3/02

(52) U.S. Cl. 225/91

(57) ABSTRACT

A material wrap dispenser apparatus which includes separate chambers for housing rolls of the same material or different materials to independently direct the flow of those materials towards a respective blade. The dispenser has a shape that is attractive and easily and compactly, stores up to three different materials vertically, and allows for the materials to be pulled from the dispenser with the thumb and index finger of both hands to the desired length and easily cut to that length with a razor blade style cutter while keeping the material as close to the work surface as possible.

### FIELD OF THE INVENTION

This invention relates to devices used to dispense and cut rolled, household or commercial wrapping materials.

### BACKGROUND OF THE INVENTION

Dispensing and cutting devices for wrapping materials have been produced in many applications in the past. The typical operation of a wrap dispensing and cutting device is to dispense a chosen material from a small storage area by pulling it out of the device with one hand and then ripping it across a serrated cutting edge to separate the material from the roll.

The cutting blade on conventional dispensing devices is typically a serrated edge on the device. Some of the problems that can occur from using a conventional serrated cutting edge are that the blade can become bent or dull before the roll of material is finished. Also, the edge is usually always exposed leaving a razor sharp edge upon which a user may accidentally get cut. This is why a cutting blade device similar to the “Plastic Cutting Device” disclosed in U.S. Pat. No. 4,960,022 will be employed in a wrap dispenser consistent with the present invention as described herein.

Some of the problems that occur while using a conventional cardboard box type wrap dispenser are that the box containers can get bent out of shape and destroyed while attempting to open the box, along with continuously having to remove the box from a drawer or storage area. This will eventually render the box useless before the wrap is completely used up making it even more difficult to cut the wrap to the desired length. Also, typical boxes are usually unsightly and are something that would not be left out in view when not being used.

Many existing wrap dispensers when separately used to house multiple different materials take up a huge amount of workspace on the work surface where the wrapping process is actually to be performed.

Furthermore, many conventional wrap dispensers do not allow the user to dispense the wrapping material after one simple, manual, pulling motion and then have it within inches from the work surface to allow the substance to be wrapped to be easily placed on the desired location of the wrap material before actually having to cut the material to the desired length. Many conventional wrap dispensers require the user to remove and cut the wrap first, then place the wrapping material on a work surface in two or more steps. This creates a longer and more tedious wrapping process for each item to be wrapped and allows for the material to become wrinkled and non-uniform when beginning the wrapping process.

In view of these problems, it is desirable to have a manual, wrap dispensing machine, that can accommodate or be expanded to accommodate multiple rolls of different types of wrapping materials, that allows for several types of materials to be stacked vertically thus saving space, that utilizes a cutting blade similar in nature to the cutting blade in U.S. Pat. No. 4,960,022, and that allows the user to dispense the wrapping material after one simple pulling motion and then have it within inches from the work surface, that is an attractive accessory to the environment in which it is used.

### SUMMARY OF THE INVENTION

Methods and articles of manufacture consistent with the present invention provide a wrapping material dispenser suitable for wrapping various items.

In one embodiment, a wrap dispenser is provided that includes separate or non separate, stackable or non stackable enclosures having internal dispensing channels or chambers keeping the various materials to be dispensed separated. The materials to be dispensed are entered into the dispenser through an external access in the dispensing units. Further, the dispenser has a blade assembly holder and adapter in which to allow for the placement, replacement, and removal of the cutting blade assembly. Behind the blade assembly are access ports in which a person's fingers may be inserted above and below the material to be dispensed assuring a quick and accurate grasp of the material. The material being dispensed, exits the dispenser between one and five inches from the surface of the work table giving the person performing the wrapping procedure the ability to place the object to be wrapped on the wrapping material, and on the work surface before cutting the material thus saving time. The dispensing unit is made from any material, plastic, metal, or other that will allow for the smooth passage, without friction, of many various dispensed materials that would come in contact with its surface.

The dispenser allows for multiple materials to remain accessible from one location and ready for use within seconds.

The operation of the dispenser is such that the rolls of material are loaded into the dispenser, held in place and suspended by a removable rod running through the center of the roll, or held in place by movable end inserts that may be solid or mechanical made with ball bearings, and then fed through the dispensing rollers or chamber until the material reaches the cutting blade. The material being dispensed is then manually grabbed with the fingers and thumbs of each hand and pulled forward across the work surface until the desired length of the material is achieved. Then, the cutting blade may be slid across the material separating it from the roll. The un-dispensed material is then designed to remain elevated and resting on the cutting blade edge and blade assembly holder and adapter until the next piece of material is dispensed.

The bottom of the dispensing unit has feet, suction cups, or anchor portals that prevent the dispenser from slipping or moving while the material to be dispensed is being pulled from the dispenser. However, by this method of attaching the dispenser to the work surface, the dispenser remains portable and easily relocated.

In yet another embodiment, the wrapping materials are assumed to be in roll form and have a hollow core in which the roll is to be supported in the dispenser by an internal mechanism of either a material holding rod that travels the entire length of the roll, or material holding inserts that hold the ends of the roll in a suspended fashion allowing for the roll to spin freely while the material is being dispensed.

In yet another embodiment, the wrapping material may or may not have a hollow core in which the roll is to be supported in the dispenser by an internal mechanism. In this instance, the rolls may be elevated by rollers or small wheels that for the roll to spin freely while the material is being dispensed. Similar roller guides may be used within the internal chambers to assure the material glides smoothly through the internal chambers.

### BRIEF DESCRIPTION OF THE DRAWINGS

The Accompanying drawings, which are in and constitute a part of this specification, illustrate an implementation of the present invention and, together with the description, serve to explain the advantages and principles of the invention.

FIG. 1 depicts an exemplary side view cut away of one embodiment of a wrap dispenser consistent with the present invention.

FIG. 2 depicts an exemplary front view of one embodiment of a wrap dispenser consistent with the present invention.

FIG. 3 depicts an exemplary back view of one embodiment of a wrap dispenser consistent with the present invention.

### DETAILED DESCRIPTION OF THE DRAWINGS

Referring now to the drawings which depict one embodiment consistent with the present invention. Wherever possible, the same reference numbers will be used throughout the drawings and the following description to refer to the same or like parts.

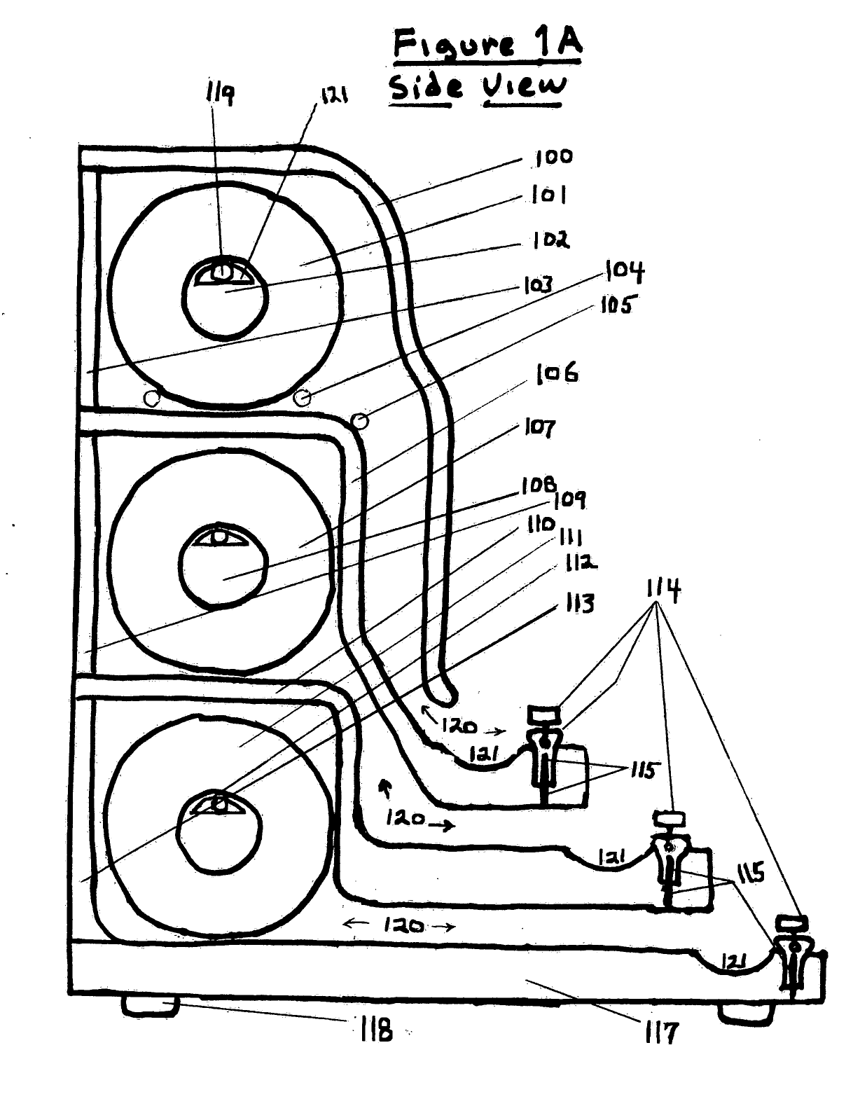

FIG. 1 depicts an exemplary side view cut away of one embodiment of a wrap dispenser 50 consistent with the present invention. The wrap dispenser includes an enclosure 52 having an upper chamber housing 100, a central chamber housing 106 disposed below and supporting the upper chamber housing 100, and a lower chamber housing 110 disposed below and supporting the central chamber 106. The dispenser also includes an upper external access 103 to load material into the upper chamber housing 100, a center internal access 109 to load material into the central chamber housing 106, and a lower internal access 113 to load material into the lower chamber housing 110. Internal access in this case has three separate access points but the access may consist of one larger access. The wrap dispenser 50 is designed so that the material dispensed from each roll 101, 107, and 111 is all within four inches vertically away from the surface in which the dispenser is placed for use.

The material rolls 101, 107, and 111 are shown in the loaded position within the dispenser 50. The material rolls are an example of materials such as plastic, wax paper and foil that are wrapped about a tube or hollow core 102, 108, and 112.

Each chamber housing 100, 106 and 110 includes a cutting blade 114 near and external to an internal chamber opening 120 to the respective chamber housing 100, 106 and 110. The cutting blades 114 are also shown FIG. 1 attached, in the ready-to-use position on the dispenser.

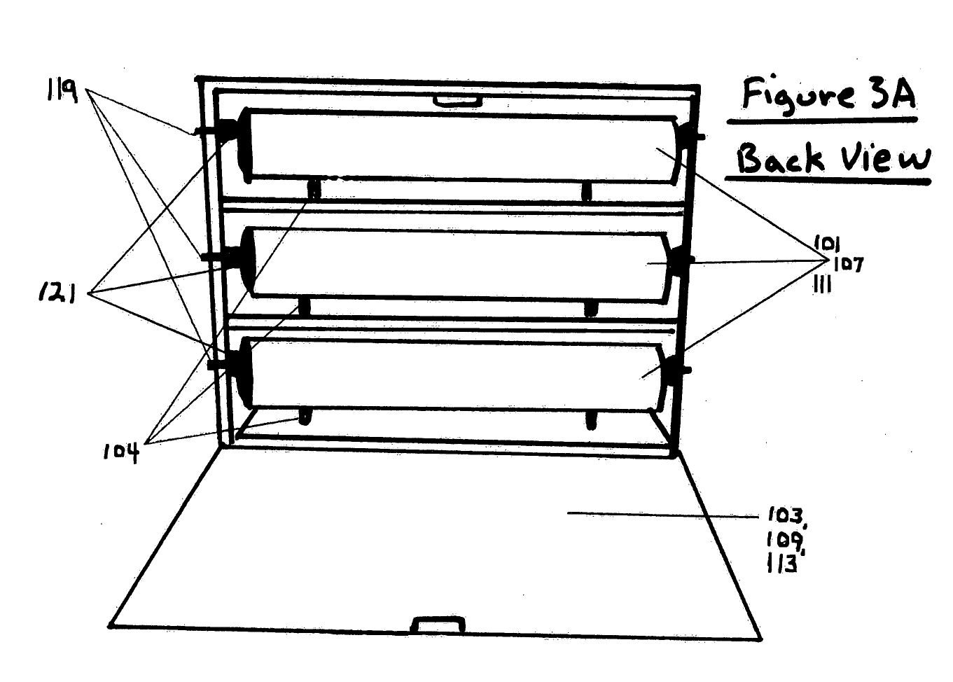

The material is held in place with either the material holding rod 119 or the material holding inserts 121 as shown in FIG. 3. Should the rolls not have a hollow tube or core 102,109,112, or a core that does not fit with the holding inserts 121, material rollers 104 may be used to hold and facilitate rolling and unwrapping the material. Roller guides 105 may also be used to assist the material 101, 107, and 111 glide through the internal chambers 120 during the unwrapping process.

As the material is dispensed off the rolls 102, 107, and 111, it passes through the internal chamber 120 and out to the respective cutting blade assembly 114. The material can be grabbed with the fingers through the access ports 122 which allow the index finger to be inserted under the material as it exits the internal chamber 120.

The base 117 of the dispenser 50 forms the bottom of the lower chamber 110. Rubber feet or suction cups 118 may be mounted to the base 117.

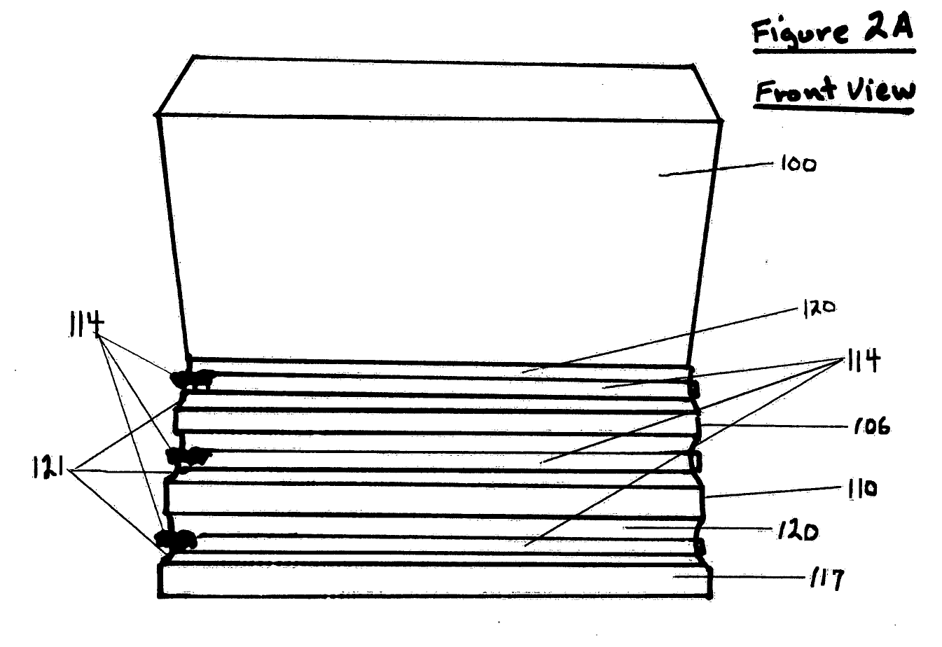

FIG. 2 depicts an exemplary front view of the wrap dispenser 50 consistent with the present invention.

In this implementation, the upper housing chamber 100 has a square shape. However, the chamber's 100 shape may also be curved or cylindrical. The material to be dispensed is pulled out through the internal chamber 120 across the cutting blade assembly 114. The cutting blade assembly 114 shown shows the actual blade 114a in a position all the way to the left side of the assembly. The cutting blade is mounted in a channel 115 and the blade 114a is moved from left to right or right to left, consistent with U.S. Pat. No. 4,960,022, to cut off a piece of the material for wrapping an article such as a food item for storage.

FIG. 3 50 depicts an exemplary back (rear) view of the wrap dispenser 50 consistent with the present invention. Here, the internal access 103, 109, 113 to the chamber housings 100,106 and 110 is a single panel but may also be three separate panels pivotally attached to the rear of the dispenser 50. The material rolls 101, 107, and 111 are shown loaded into the dispenser in accordance with the present invention.

The material rolls may be held in position using various techniques where position is defined as an area within the dispenser 50 that allows the roll to spin freely without touching the physical structure of the dispenser causing friction which makes the material 101,107, 111 more difficult to be dispensed. In the implementation shown in FIG. 3, a material holding rod 119 is used to hold a respective material roll 101, 107, or 111 in position. In yet another embodiment, material holding inserts 121 may be disposed between the ends of each material roll 101,107 and 111 and a corresponding internal wall of the respective chamber housing 100, 106 and 110 to assist in maintaining the position of the material roll 101, 107, and 111 relative to the respective chamber housing.

In yet another embodiment, material rollers may be used 104 to assist with the release of the material from the roll.

What is claimed is:

1. A material wrap dispenser apparatus, comprising an enclosure having a plurality of disposed vertically relative to each other and configured to chambers, hold a roll of wrapping material, each chamber having an opening through which material from the respective roll is pulled through and a plurality of cutting blade assemblies, each disposed at the opening of a respective one of the chambers.

2. The dispenser apparatus of claim 1, wherein
the enclosure has a single door for accessing each of the chambers.

3. The dispenser apparatus of claim 1, wherein
the chambers are vertically stackable upon each other,

4. The dispenser apparatus of claim 1, wherein
each chamber has a separate access door.

5. The dispenser apparatus of claim 1, wherein
each chamber housing has a horizontal channel running across the front of the chamber housing near the opening of the chamber housing and each cutting blade assembly is irremovably disposed in a corresponding channel.

6. The dispenser apparatus of claim 1, wherein
the sides of the apparatus have notched holes or finger insert material access ports which allow the index finger to be inserted under the material as it exits the internal chamber.

7. The dispenser apparatus of claim 1,
further comprising feet disposed in a bottom one of the chambers to prevent slippage and to secure the apparatus to a fixed surface.

8. The dispenser apparatus of claim 1,
further comprising a plurality of rods each adapted to receive a respected one of the rolls of material and irremovably disposed within a respective chamber such that the respective material roll of spins freely within the respective chambers.

9. The dispenser apparatus of claim 1,
further comprising a plurality of internal rollers disposed within a respective chamber so that the internal rollers support and enable rolling and unwrapping of a respective one of the rolls of material.

10. The dispenser apparatus of claim 1, wherein
Each of the chambers is stacked so that the material from each roll is dispensed at or within four inches of the work surface upon which the lowest of the chambers is disposed.
